(19) United States
(12) Patent Application Publication
(10) Pub. No.: US 2020/0364722 A1
(43) Pub. Date: Nov. 19, 2020

(54) BIOMETRIC PAYMENT PROCESSING THAT CONFIGURES PAYMENT PROCESSING FOR A DETERMINED MERCHANT OF RECORD

(71) Applicant: Alclear, LLC, New York, NY (US)

(72) Inventor: Joe Trelin, New York, NY (US)

(21) Appl. No.: 16/874,949

(22) Filed: May 15, 2020

Related U.S. Application Data
(60) Provisional application No. 62/849,131, filed on May 16, 2019.

(51) Int. Cl. G06Q 20/40; G06Q 20/36; G06Q 20/10; G06Q 40/02; G06Q 20/02; G06Q 30/06; G06Q 40/08; G06Q 30/00; G06Q 10/06; H04L 29/06; G06F 16/23

(52) U.S. Cl. CPC G06Q 20/40145; G06Q 20/3672; G06Q 20/105; G06Q 20/108; G06Q 40/02; G06Q 20/027; G06F 16/2379; G06Q 40/08; G06Q 30/0185; G06Q 10/06316; H04L 63/0861; H04L 63/0853; G06Q 30/0607

(57) ABSTRACT

A biometric payment processing system that configures payment processing for a determined merchant of record is operative to receive a digital representation of a biometric and transaction information for a transaction; use the digital representation of the biometric to retrieve identity information; determine a merchant of record for the transaction; and submit a payment processing request for the transaction as the merchant of record to a vault. In some implementations, the system may retrieve a payment processing configuration for the merchant of record and configure the payment processing request accordingly. In other implementations, the system may specify in the payment processing request a payment processing configuration for the merchant of record that the vault will use. In various implementations, the payment processing request may be in the form of a secure token that is passed to the vault.

### CROSS-REFERENCE TO RELATED APPLICATION(S)

This application is a nonprovisional patent application of and claims the benefit of U.S. Provisional Patent Application No. 62/849,131, filed May 16, 2019 and titled “Biometric Payment Processing that Configures Payment Processing for a Determined Merchant of Record,” the disclosure of which is hereby incorporated herein by reference in its entirety.

### FIELD

The described embodiments relate generally to biometric payment processing. More particularly, the present embodiments relate to biometric payment processing that configures payment processing for a determined merchant of record.

### BACKGROUND

Use of biometrics (such as one or more fingerprints, vein scans, palm-vein scans, voiceprints, facial images, retina images, iris images, deoxyribonucleic acid sequences, heart rhythms, gaits, and so on) to establish a person's identity is increasingly common. Biometrics may be used to unlock electronic devices, retrieve sensitive information, enter secure areas (such as airport terminals, event venues, and so on), rent or purchase goods and/or services, and so on. A variety of different technologies may be used in a variety of different implementations to establish a person's identity using biometrics.

Merchants and/or other entities may accept payments for transactions. In some situations (such as transactions involving controlled substances like alcoholic beverages, nicotine related products, other age restricted products, prescription medications, purchase amount or frequency regulated cold remedies or other medicines, and so on; insurance billing, and so on), the merchant may be required to be authorized to perform the transactions. In various situations, processing payments for the transactions may involve various processes for performing reconciliation (e.g., verifying the integrity of data between payment processing system records and merchant system records).

### SUMMARY

The present disclosure relates to biometric payment processing that configures payment processing for a determined merchant of record. A system may receive a digital representation of a biometric and transaction information for a transaction; use the digital representation of the biometric to retrieve identity information; determine a merchant of record for the transaction; and submit a payment processing request for the transaction as the merchant of record configured according to the identity information, the transaction information, and a payment processing configuration for the merchant of record to a vault. In some implementations, the system may retrieve the payment processing configuration and configure the payment processing request accordingly. In other implementations, the system may specify in the payment processing request a payment processing configuration that the vault will use. In various implementations, the payment processing request may be in the form of a secure token that is passed to the vault.

In various embodiments, a system for biometric payment processing that configures payment processing for a determined merchant of record includes at least one non-transitory storage medium that stores instructions and at least one processor. The at least one processor executes the instructions to receive a digital representation of a biometric and transaction information for a transaction; use the digital representation of the biometric to retrieve identity information; determine a merchant of record for the transaction; configure a token according to the identity information, the transaction information, and a payment processing configuration for the merchant of record; and submit the token to a vault to process a payment for the transaction as the merchant of record.

In some examples, configuring the token according to the payment processing configuration for the merchant of record includes retrieving the payment processing configuration for the merchant of record and configuring the token using a sequence of processes included in the payment processing configuration for the merchant of record. In various examples, configuring the token according to the payment processing configuration for the merchant of record includes including an identification of the configuration to use for processing payment.

In a number of examples, the identity information includes a payment account identifier. In some examples, the identity information includes a name.

In various examples, the payment processing configuration for the merchant of record specifies a sequence of processes that the merchant of record uses to process payments. In a number of implementations of such examples, the vault has a connection to a gateway that has the ability to configure connections for performing the sequence of processes.

In some embodiments, a system for biometric payment processing that configures payment processing for a determined merchant of record includes at least one non-transitory storage medium that stores instructions and at least one processor. The at least one processor executes the instructions to receive a digital representation of a biometric and transaction information for a transaction; use the digital representation of the biometric to retrieve identity information; determine a merchant of record for the transaction; retrieve a payment processing configuration for the merchant of record; and submit a payment processing request for the transaction as the merchant of record to a vault using the identity information, the transaction information, and the payment processing configuration.

In various examples, the transaction is a restricted transaction. In some implementations of such examples, the merchant of record is authorized to perform the transaction and the system is not authorized to perform the transaction. In a number of implementations of such examples, the transaction is for an age restricted product. In various implementations of such examples, the transaction is for a prescription medication. In a number of implementations of such examples, the identity information includes an insurance identifier.

In some examples, the system enables instant reconciliation and/or nearly instantaneous reconciliation (e.g., within fifteen minutes, within an hour, within a same day, and so on) for the merchant of record.

In a number of embodiments, a system for biometric payment processing that configures payment processing for a determined merchant of record includes at least one non-transitory storage medium that stores instructions and at least one processor. The at least one processor executes the instructions to receive a digital representation of a biometric and transaction information for a transaction; use the digital representation of the biometric to retrieve identity information; determine a merchant of record for the transaction; submit a payment processing request for the transaction as the merchant of record that specifies a payment processing configuration for the merchant of record to a vault using the identity information and the transaction information.

In some examples, the payment processing request is a first payment processing request, the transaction is a first transaction, the merchant of record is a first merchant of record, the payment processing configuration is a first payment processing configuration, and the at least one processor is operative to submit a second payment processing request for a second transaction as a second merchant of record that specifies a second payment processing configuration for the second merchant of record to the vault. In various implementations of such examples, the first payment processing configuration specifies a first sequence of processes that the first merchant of record uses to process first payments, the second payment processing configuration specifies a second sequence of processes that the second merchant of record uses to process second payments, and the first sequence of processes is different from the second sequence of processes.

In a number of examples, the at least one processor determines whether the merchant of record is allowed to perform the transaction. In some examples, the transaction information includes a payment account identifier and the at least one processor verifies the payment account identifier using the identity information. In various examples, the payment processing configuration specifies a sequence of processes to perform credit card reconciliation for the merchant of record.

### BRIEF DESCRIPTION OF THE DRAWINGS

The disclosure will be readily understood by the following detailed description in conjunction with the accompanying drawings, wherein like reference numerals designate like structural elements.

FIG. 1 depicts a first example system for biometric payment processing that configures payment processing for a determined merchant of record.

FIG. 2 depicts an example of interrelated software modules that may be used to implement the system of FIG. 1.

FIG. 3 depicts a flow chart illustrating a first example method for biometric payment processing that configures payment processing for a determined merchant of record. This method may be performed by the system of FIG. 1.

FIG. 4 depicts a flow chart illustrating a second example method for biometric payment processing that configures payment processing for a determined merchant of record. This method may be performed by the system of FIG. 1.

FIG. 5 depicts a flow chart illustrating a third example method for biometric payment processing that configures payment processing for a determined merchant of record. This method may be performed by the system of FIG. 1.

FIG. 6 depicts a flow chart illustrating a fourth example method for biometric payment processing that configures payment processing for a determined merchant of record. This method may be performed by the system of FIG. 1.

FIG. 7 depicts a flow chart illustrating a fifth example method for biometric payment processing that configures payment processing for a determined merchant of record. This method may be performed by the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

A merchant and/or other entity that accepts a payment for a transaction may use an identity system to process payments using stored payment information. For example, the merchant may receive identification information from a person (such as one or more digital representations of one or more biometrics, one or more passwords, one or more account logins, and so on) that may be used to access identity information stored by an identity system. The identity information may include payment information. As such, the merchant may provide the identification information and transaction information for a transaction to the identification system, which may use the identification information and transaction information to submit a payment request for the transaction to a payment processor. In this way, the person does not have to provide the payment information to the merchant. This may be more convenient and secure, both for the person and the merchant.

However, the transaction may be one where the merchant needs to be authorized (such as authorized by a governmental authority in cases where entities are required to be licensed or otherwise legally licensed to perform transactions, by a civil authority in cases where an entity has the ability to contractually control whether or not entities may perform transactions, and so on) in order to perform the transaction, to be the “merchant of record” (the entity that is authorized, and held liable, by a financial institution to process a consumer's financial account transactions). For example, this may include transactions involving controlled substances like alcoholic beverages, nicotine related products, other age restricted products, prescription medications, purchase amount or frequency regulated cold remedies or other medicines, and so on; insurance billing, and so on. In such a situation, the identity system may have to become authorized to perform the transaction or the merchant may be unable to use the identity system to process payments for transactions.

Further, different merchants may perform different sequences of processes as part of processing payments for transactions. For example, different merchants may perform different sequences of processes as part of credit card and/or other payment reconciliation (e.g., verifying the integrity of data between payment processing system records and merchant system records). In such a situation, the identity system may need to be configured to perform such a sequence of processes. This may necessitate that a separate identity system be implemented for each merchant or the merchant may be unable to use the identity system to process payments for transactions. This may also result in significant delays for reconciliation, which may be problematic or even unacceptable for the merchant.

The following disclosure relates to biometric payment processing that configures payment processing for a determined merchant of record. A system may receive a digital representation of a biometric and transaction information for a transaction; use the digital representation of the biometric to retrieve identity information; determine a merchant of record for the transaction; and submit a payment processing request for the transaction as the merchant of record configured according to the identity information, the transaction information, and a payment processing configuration for the merchant of record to a vault. In some implementations, the system may retrieve the payment processing configuration and configure the payment processing request accordingly. In other implementations, the system may specify in the payment processing request a payment processing configuration that the vault will use. In various implementations, the payment processing request may be in the form of a secure token that is passed to the vault.

In this way, the system may be able to perform biometric payment processing for a variety of different merchants and/or other entities. The system may be able to perform the payment processing as the merchant in the way that the merchant needs the payment processed, avoiding issues with required authorizations to perform transactions (as the system may function as the proxy for the merchant, thus being authorized to perform the transaction as a proxy for the authorized merchant even when the system would not otherwise be authorized outside of the proxy relationship), different payment processing procedures, and so on. The system may even allow instantaneous or nearly instantaneous reconciliation. As a result, the system may be capable of performing functions that other payment processing systems would not be able to perform. Further, the system is able to perform such functions more efficiently using fewer hardware and/or software components while consuming less hardware and/or software resources and reducing duplicate components and/or otherwise improving hardware and/or software performance.

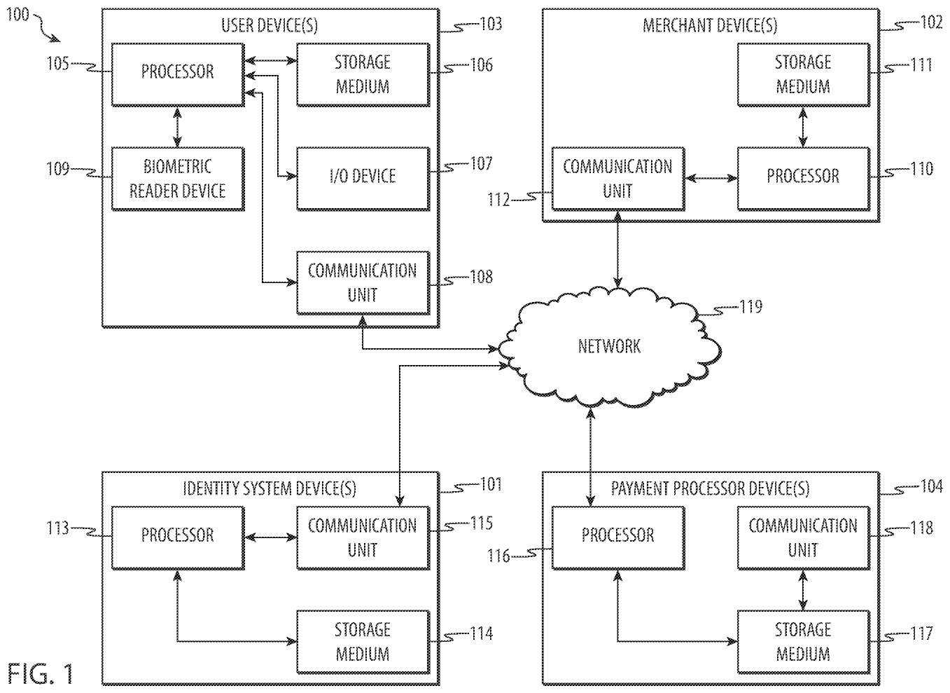

These and other embodiments are discussed below with reference to FIGS. 1-7. However, those skilled in the art will readily appreciate that the detailed description given herein with respect to these Figures is for explanatory purposes only and should not be construed as limiting.

FIG. 1 depicts a first example system 100 for biometric payment processing that configures payment processing for a determined merchant of record. The system 100 may include one or more identity system devices 101, merchant devices 102, user devices 103, payment processor devices 104, and/or other electronic devices that may communicate with each other via one or more wired and/or wireless communication networks 119. The identity system device 101 may communicate with one or more of the merchant device 102, the user device 103, and the payment processor device 104 as part of biometric payment processing configured for a merchant of record associated with the merchant device 102. For example, the payment processor device 104 may implement a vault (a protected secure storage area implemented by one or more processing units executing one or more instructions that isolates financial data for payment processing from other equipment) that the identity system device 101 is operable to communicate with as part of biometric payment processing configured for a merchant of record associated with the merchant device 102.

The identity system device 101 may receive one or more digital representations of one or more biometrics and transaction information for one or more transactions. For example, a person may use the user device 103 to request a transaction from the merchant device 102 and provide the biometric, though in other examples the merchant device 102 and the user device 103 may be incorporated into a single device. In some implementations, the identity system device 101 may receive the digital representation of the biometric and the transaction information in the form of a data structure that may include one or more digital representations of one or more biometrics and/or hashes or other representations of one or more modalities, one or more instructions regarding processing of the digital representations of the biometrics, one or more requests (such as requests to process payment related to transaction information, requests to determine one or more identities, requests to provide attestations regarding one or more identities, and so on), and so on.

The identity system device 101 may use the digital representation of the biometric to retrieve identity information. For example, the identity system device 101 may store and/or track a variety of different information related to the identities of various people. This identity information may include, but is not limited to, one or more names, addresses, telephone numbers, notification preferences and/or other notification information, social security numbers, frequent flyer numbers, financial data, financial account numbers, verified ages, boarding pass data, flight data, movement data, historic movement data, and so on. The identity system device 101 may control access to the identity information as part of responding to requests and/or providing one or more attestations. The identity system device 101 may control access to the identity information using various mechanisms such as through matching of a received hash and/or other digital representation of a biometric with biometric data associated with the identity information, determining that a requestor is authorized to access identity data, receipt of authorized account logins and/or passwords, authorization tokens, and/or other access control mechanisms, and so on.

The identity system device 101 may determine a merchant of record for the transaction. For example, the transaction information may specify a merchant associated with the merchant device 102 to use as the merchant of record for the transaction. By way of another example, the data structure mentioned above may identify the merchant to use as the merchant of record. In yet another example, the identity system device 101 may determine the merchant of record based on the merchant device 102 from which the transaction information and/or the digital representation of the biometric are received, the network 119 via which the transaction information and/or the digital representation of the biometric are received, and so on.

The identity system device 101 may submit a payment processing request for the transaction as the merchant of record configured according to the identity information, the transaction information, and a payment processing configuration for the merchant of record to a vault implemented by the payment processor device 104.

The vault may have a connection to a gateway and/or other electronic device that may have the ability to configure connections for performing one or more sequences of processes that may have been specified in the payment processing configuration. In this way, the system 100 may be able to perform biometric payment processing for a variety of different merchants and/or other entities. The system 100 may be able to perform the payment processing as the merchant in the way that the merchant needs the payment processed, avoiding issues with required authorizations to perform transactions (as the identity system device 101 may function as the proxy for the merchant device 102, thus being authorized to perform the transaction as a proxy for the merchant device 102, even when the identity system device 101 would not otherwise be authorized outside of the proxy relationship), different payment processing procedures, and so on. The system 100 may even allow instantaneous or nearly instantaneous reconciliation (e.g., within fifteen minutes, within an hour, within a same day, and so on).

By way of example, the identity system device 101 may configure the payment processing request using a name from the identity information, one or more credit/debit card and/or other financial account numbers and/or other payment information from the identity information, and so on. The identity system device 101 may also configure the payment processing request using a transaction amount from the transaction information, a merchant of record from the transaction information, a transaction date from the transaction information, transaction details from the transaction information, and so on. The identity system device 101 may further configure the payment processing request using a sequence of processes to perform for the merchant of record as part of processing payments that are derived from a payment processing configuration associated with the merchant of record (such as one or more processes to perform for reconciliation for the merchant of record, which may include comparing inbound and/or outbound credit card and/or other payment statements to internal and/or other ledgers systems and/or identifying and/or resolving discrepancies in such, comparing inbound and/or outbound credit card and/or other payment statements to internal and/or other ledgers systems to inventory systems and/or identifying and/or resolving discrepancies in such, making journal entries for various systems to correct timing items or errors in payment statements, importing data from general ledgers systems and/or credit card and/or other payment statements, and so on), a specification of a payment processing configuration to use for the merchant of record as part of processing payment, and so on.

In some implementations, the identity system device 101 may retrieve the payment processing configuration and configure the payment processing request accordingly. For example, the identity system device 101 may store payment processing configurations for each merchant of record that the identity system device 101 is operative to submit payment processing requests as. Each payment processing configuration may detail the sequence of processes to perform for that merchant of record as part of processing payment (such as one or more processes to perform for reconciliation).

By way of illustration, a pharmacy may sell a particular prescription medication under an instant rebate program. The instant rebate program may specify that the pharmacy is to sell the particular prescription medication at a discount that will be offset by payments from the instant rebate program provider after sales of the particular prescription medication occur. As such, the pharmacy may not receive payment for any of the particular prescription medication sold until reconciliation is performed where payment system statements involved in the sale of the particular prescription medication are reconciled with the pharmacies internal ledger systems and/or the pharmacy's inventor systems and payment request to the instant rebate program provider is then made accordingly. However, as the identity system device 101 in the system 100 may submit payment processing requests as the pharmacy configured according to a payment processing configuration for the pharmacy specifying performance of these operations, payment may be requested from the instant rebate program provider upon each transaction rather than requiring the pharmacy to wait for a periodic payment processor accounting statement that can then be used for reconciliation, delaying request for payment and thus eventual payment by the instant rebate program provider.

In other implementations, the identity system device 101 may specify in the payment processing request a payment processing configuration that the vault will use. For example, the payment processor device 104 may identify the payment processing configuration from the payment processing request, retrieve the specified payment processing configuration, and configure the payment processing request accordingly. The payment processor device 104 may store payment processing configurations for each merchant of record that the identity system device 101 is operative to submit payment processing requests as.

In various implementations, the payment processing request may be in the form of a secure payment request token that is passed to the vault. For example, the identity system device 101 may tokenize at least part of the identity information and/or the transaction information, port the payment request token to the vault as a waystation, and allow the payment request token to be used via the vault and a connected gateway to configure connections to any ancillary processes that a merchant might use as part of processing payments.

The user device 103 may be any kind of electronic device. The user device 103 may be termed a “user device” due to being operable by one or more users regardless whether or not such users own and/or control such a device. Examples of such devices include, but are not limited to, one or more desktop computing devices, laptop computing devices, mobile computing devices, wearable devices, tablet computing devices, mobile telephones, smart phones, printers, displays, kiosks, vehicles, kitchen appliances, entertainment system devices, digital media players, and so on. The user device 103 may include one or more processors 105 and/or other processing units and/or controllers, one or more non-transitory storage media 106 (which may take the form of, but is not limited to, a magnetic storage medium; optical storage medium; magneto-optical storage medium; read only memory; random access memory; erasable programmable memory; flash memory; and so on), one or more input and/or output devices 107 (such as one or more keyboards, computer mice, touch screens, touch pads, track pads, microphones, speakers, displays, buttons, dials, switches, printers, and so on), one or more communication units 108, one or more biometric reader devices 109 (such as a fingerprint scanner, a vein scanner, a palm-vein scanner, an optical fingerprint scanner, a phosphorescent fingerprint scanner, a still image and/or video camera, a 2D and/or 3D image sensor, a capacitive sensor, a saliva sensor, a deoxyribonucleic acid sensor, a heart rhythm monitor, a microphone, and so on), and/or one or more other components. The processor 105 may execute one or more sets of instructions stored in the non-transitory storage media 106 to perform various functions, such as using the biometric reader device 109 to obtain one or more digital representations of one or more biometrics (such as one or more hashes and/or other digital representations of one or more fingerprints, vein scans, palm-vein scans, voiceprints, facial images, retina images, iris images, deoxyribonucleic acid sequences, heart rhythms, gaits, and so on) for a person, communicating with the merchant device 102 via the network 119 using the communication unit 108, receiving and/or submitting one or more transaction requests, providing one or more obtained digital representations of biometrics, and so on.

Similarly, the merchant device 102 may be any kind of electronic device and/or cloud and/or other computing arrangement and may include one more processors 110, non-transitory storage media 111, communication units 112, and/or other components. The processor 110 may execute one or more sets of instructions stored in the non-transitory storage media 111 to perform various functions, such as communicating with the user device 103 and/or the identity system device 101 via the network 119 using the communication unit 112, providing one or more transaction options, receiving one or more transaction requests, receiving and/or providing one or more received digital representations of biometrics, providing transaction information for one or more transactions, and so on. In implementations where the user device 103 is omitted, the merchant device 102 may include the biometric reader device 109 and/or include a connection thereto.

Likewise, the identity system device 101 may be any kind of electronic device and/or cloud and/or other computing arrangement and may include one more processors 113, non-transitory storage media 114, communication units 115, and/or other components. The processor 113 may execute one or more sets of instructions stored in the non-transitory storage medium 114 to perform various functions, such as storing biometric data for people and associated identity information (such as one or more names, addresses, telephone numbers, financial data, financial account numbers, verified ages, insurance identifiers, payment account identifiers, and so on), receiving one or more digital representations of biometrics, matching one or more received digital representations of biometrics to stored biometric data, retrieving identity information associated with stored biometric data matching one or more received digital representations of biometrics, providing retrieved identity information, communicating with the merchant device 102 via the network 119 using the communication unit 115, determining and/or retrieving one or more merchants of record, retrieving one or more payment processing configurations, identifying one or more payment processing configurations, submitting one or more payment requests, generating one or more payment request tokens, and so on.

Similarly, the payment processor device 104 may be any kind of electronic device and/or cloud and/or other computing arrangement and may include one more processors 116, non-transitory storage media 117, communication units 118, and/or other components. The processor 116 may execute one or more sets of instructions stored in the non-transitory storage media 117 to perform various functions, such as communicating with the identity system device 101 and/or the merchant device 102 (and/or other gateways, processes, computing and/or other electronic devices, and so on) via the network 119 using the communication unit 118, receiving one or more payment processing requests and/or tokens, determining one or more payment processing configurations, performing one or more processes related to a payment processing configuration, processing one or more payments, and so on.

Although the system 100 is illustrated and described as including particular components arranged in a particular configuration that perform particular functions, it is understood that this is an example. In various implementations, various arrangements of various components that perform various functions may be implemented without departing from the scope of the present disclosure.

For example, the system 100 is illustrated and described as including the merchant device 102 and the user device 103 that includes the biometric reader device 109. However, it is understood that this is an example. In various implementations, the user device 103 may be omitted and the merchant device 102 may include the biometric reader device 109 and/or receive transaction requests directly. Various configurations are possible and contemplated without departing from the scope of the present disclosure.

By way of another example, the system 100 is illustrated and described as including the merchant device 102 and the user device 103 communicating with each other, the identity system device 101 and the merchant device 102 communicating with each other, and the identity system device 101 and the payment processor device 104 communicating with each other. However, it is understood that this is an example. In a number of examples, various of these devices may communicate with each other in various ways to perform biometric payment processing that configures payment processing for a determined merchant of record. Various configurations are possible and contemplated without departing from the scope of the present disclosure.

By way of yet another example, the system 100 is illustrated and described as having the identity system device 101 retrieve one or more credit/debit cards and/or other financial account numbers and/or other payment information from the identity information. However, it is understood that this is an example. In a number of examples, the merchant device 102 may provide such payment information (such as situations where a person swiped a credit card, provided a credit card number, and so on) and the identity system device 101 may use the identity information to verify the payment information (such as verifying that a credit card number is valid, verifying that a person is an authorized user of a credit card, and so on). Various configurations are possible and contemplated without departing from the scope of the present disclosure.

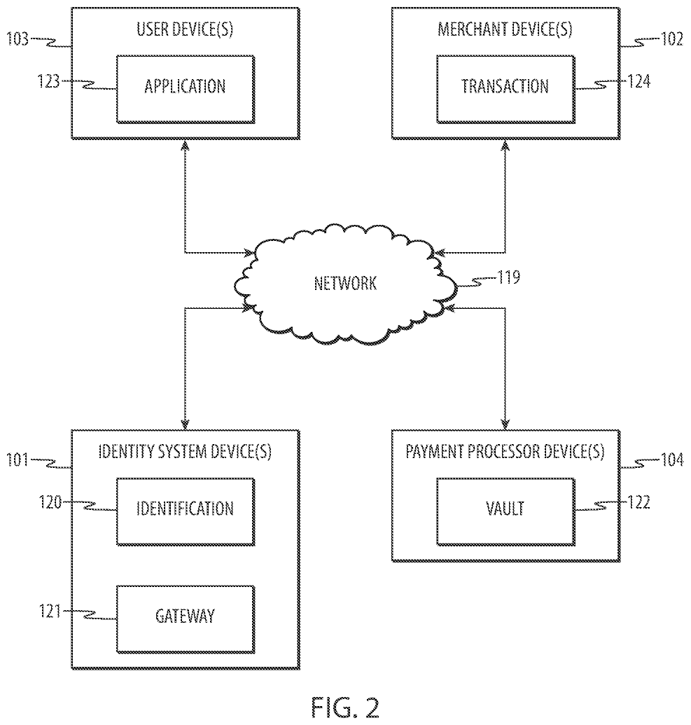

FIG. 2 depicts an example of interrelated software modules that may be used to implement the system 100 of FIG. 1. In this example, the user device 103 may implement an application 123 module or app that may be used to request a transaction from a transaction 124 module implemented by the merchant device 102 via the network 119. In response, the transaction 124 module may communicate with the identity system device 101, which may implement an identification 120 module to retrieve identity information and a gateway 121 module that interacts with a vault 122 module implemented by the payment processor device 104.

However, it is understood that FIG. 2 is an example. In other implementations, a number of different modules implemented by a number of different devices may interact in a number of different ways. Various configurations are possible and contemplated without departing from the scope of the present disclosure.

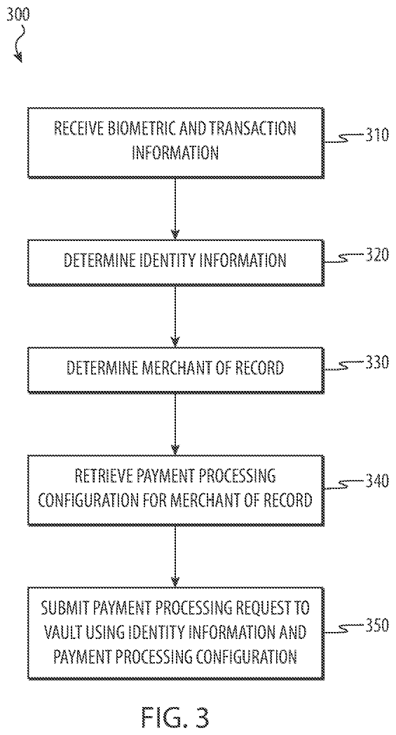

FIG. 3 depicts a flow chart illustrating a first example method 300 for biometric payment processing that configures payment processing for a determined merchant of record. This method 300 may be performed by the system 100 of FIG. 1.

At operation 310, an electronic device (such as the identity system device 101 of FIG. 1) may receive a digital representation of a biometric and transaction information for a transaction. At operation 320, the electronic device may use the digital representation of the biometric to determine or retrieve identity information. For example, the electronic device may determine identity information that is associated with stored biometric data that matches the digital representation of the biometric. The identity information may include one or more credit/debit cards and/or other financial account numbers and/or other payment information.

At operation 330, the electronic device may determine a merchant of record to use in processing payment for the transaction. For example, the transaction information may specify a merchant to use as the merchant of record for the transaction. By way of another example, a data structure in which the digital representation of the biometric and/or the transaction information are included may identify the merchant to use as the merchant of record. In yet another example, the electronic device may determine the merchant of record based on the device from which the transaction information and/or the digital representation of the biometric are received, the network via which the transaction information and/or the digital representation of the biometric are received, and so on.

At operation 340, the electronic device may retrieve a payment processing configuration for the merchant of record. For example, the electronic device may store and/or be operative to access payment processing configurations for each merchant of record that the electronic device is operative to submit payment processing requests as. Each payment processing configuration may detail the sequence of processes to perform for that merchant of record as part of processing payment (such as one or more processes to perform for reconciliation).

At operation 350, the electronic device may submit a payment processing request to a vault using the identity information and/or the payment processing configuration. The vault may have a connection to a gateway and/or other electronic device that may have the ability to configure connections for performing one or more sequences of processes that may have been specified in the payment processing configuration.

In some examples, the electronic device may submit the payment processing request using one or more secure payment request tokens. For example, the electronic device may tokenize at least part of the identity information and/or the transaction information, port the payment request token to the vault as a waystation, and allow the payment request token to be used via the vault and a connected gateway to configure connections to any ancillary processes that a merchant might use as part of processing payments. Various configurations are possible and contemplated without departing from the scope of the present disclosure.

In various examples, this example method 300 may be implemented as a group of interrelated software modules or components that perform various functions discussed herein. These software modules or components may be executed within a cloud network and/or by one or more computing devices, such as the identity system device 101 of FIG. 1.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as receiving a digital representation of a biometric and using such to determine identity information. However, it is understood that this is an example. In a number of implementations, techniques other than biometrics (such as account access, one or more logins, and so on) may be used to guard access to identity information. Various configurations are possible and contemplated without departing from the scope of the present disclosure.

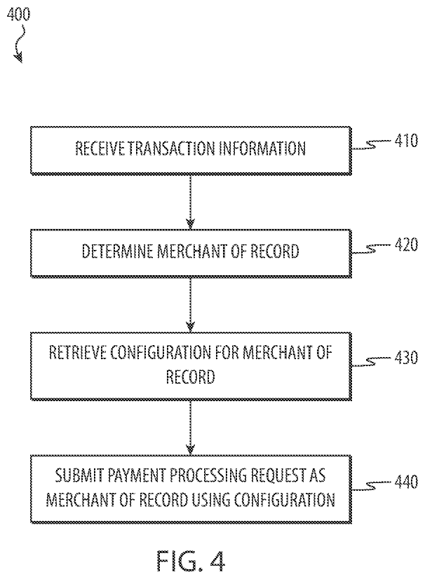

FIG. 4 depicts a flow chart illustrating a second example method 400 for biometric payment processing that configures payment processing for a determined merchant of record. This method 400 may be performed by the system 100 of FIG. 1.

At operation 410, an electronic device (such as the identity system device 101 of FIG. 1) may receive transaction information for a transaction. At operation 420, the electronic device may determine a merchant of record for the transaction. At operation 430, the electronic device may retrieve a configuration for the merchant of record to use in processing payment for the transaction as the merchant of record. The configuration may specify a sequence of processes to perform for the merchant of record as part of processing payment (such as one or more processes to perform for reconciliation for the merchant of record).

At operation 440, the electronic device may submit a payment processing request as the merchant of record using the configuration. For example, the electronic device may submit the payment processing request to a vault that is connected to a gateway that is able to configure connections to any ancillary processes that the merchant of record uses as part of processing payments.

In various examples, this example method 400 may be implemented as a group of interrelated software modules or components that perform various functions discussed herein. These software modules or components may be executed within a cloud network and/or by one or more computing devices, such as the identity system device 101 of FIG. 1.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 is illustrated and described as retrieving the configuration for the merchant of record. However, it is understood that this is an example. In some implementations, the electronic device may specify the configuration to use for the merchant of record in the payment processing request and the device that receives the payment processing request may retrieve the configuration according to the specification and process the payment processing request accordingly. Various configurations are possible and contemplated without departing from the scope of the present disclosure.

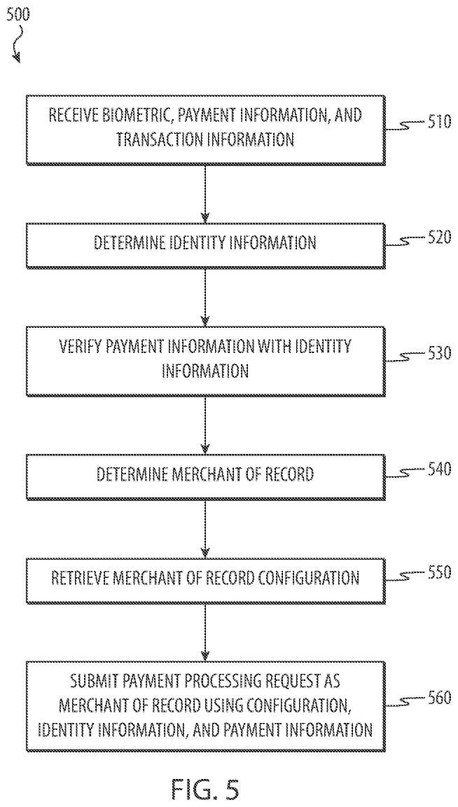

FIG. 5 depicts a flow chart illustrating a third example method 500 for biometric payment processing that configures payment processing for a determined merchant of record. This method 500 may be performed by the system 100 of FIG. 1.

At operation 510, an electronic device (such as the identity system device 101 of FIG. 1) may receive a digital representation of a biometric, payment information, and transaction information. At operation 520, the electronic device may determine identity information using the digital representation of the biometric. At operation 530, the electronic device may verify the payment information with the identity information.

For example, the electronic device may use the identity information to determine whether or not a credit card number is valid. By way of another example, the electronic device may use the identity information to determine whether or not a person is an authorized user of a credit card. Various configurations are possible and contemplated without departing from the scope of the present disclosure.

At operation 540, the electronic device may determine a merchant of record for the transaction. At operation 550, the electronic device may retrieve a merchant of record configuration for the merchant of record. At operation 560, the electronic device may submit a payment processing request as the merchant of record using the merchant of record configuration, the identity information, and/or the payment information.

In various examples, this example method 500 may be implemented as a group of interrelated software modules or components that perform various functions discussed herein. These software modules or components may be executed within a cloud network and/or by one or more computing devices, such as the identity system device 101 of FIG. 1.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is illustrated and described as receiving separate payment information and transaction information. However, in some examples, the payment information may be included in the transaction information. Various configurations are possible and contemplated without departing from the scope of the present disclosure.

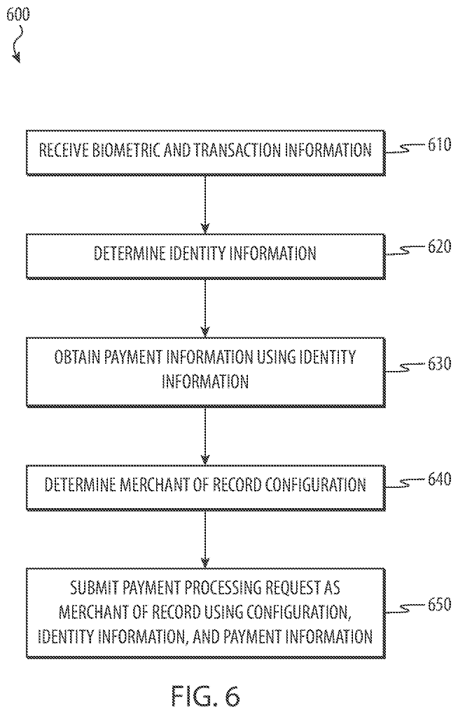

FIG. 6 depicts a flow chart illustrating a fourth example method 600 for biometric payment processing that configures payment processing for a determined merchant of record. This method 600 may be performed by the system 100 of FIG. 1.

At operation 610, an electronic device (such as the identity system device 101 of FIG. 1) may receive a digital representation of a biometric and transaction information for a transaction. At operation 620, the electronic device may determine identity information associated with the digital representation of the biometric. At operation 630, the electronic device may obtain payment information using the identity information.

For example, the identity information may include an insurance identifier. The electronic device may use the insurance identifier to obtain an insurance charge authorization number that may be processed to obtain payment for insurance coverage relating to the transaction. By way of another example, the payment information may be included in the identity information and may be obtained by deriving the payment information from the identity information.

At operation 640, the electronic device may determine a merchant of record configuration to use for processing payment for the transaction. This may involve determining a merchant of record to use for the transaction. This may also involve retrieving the configuration, retrieving an identifier that may be used to identify the configuration to use, and so on.

At operation 650, the electronic device may submit a payment processing request as the merchant of record. The payment processing request may be configured using the configuration and/or identifier for such, the identity information, and/or the payment information.

In various examples, this example method 600 may be implemented as a group of interrelated software modules or components that perform various functions discussed herein. These software modules or components may be executed within a cloud network and/or by one or more computing devices, such as the identity system device 101 of FIG. 1.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as receiving a digital representation of a biometric and using such to determine identity information. However, in a number of examples, the identity information may be received and the digital representation of the biometric may be omitted. Various configurations are possible and contemplated without departing from the scope of the present disclosure.

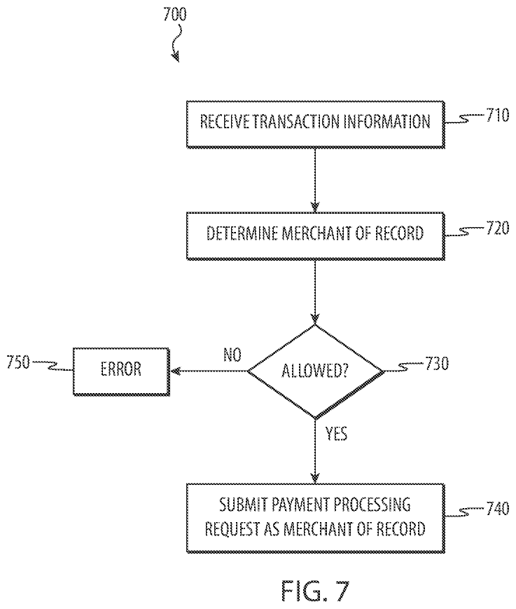

FIG. 7 depicts a flow chart illustrating a fifth example method 700 for biometric payment processing that configures payment processing for a determined merchant of record. This method 700 may be performed by the system 100 of FIG. 1.

At operation 710, an electronic device (such as the identity system device 101 of FIG. 1) may receive transaction information for a transaction. At operation 720, the electronic device may determine a merchant of record for the transaction. At operation 730, the electronic device may determine whether or not the transaction is allowed.

For example, the transaction may be a restricted transaction. The restricted transaction may relate to products that may require a license to sell, such as a liquor license for alcoholic beverages, a pharmacy license for prescription medical products, and so on. In such an example, the electronic device may determine whether or not the transaction is allowed by determining whether or not the determined merchant of record has such a license and/or authorization to perform the transaction regardless whether or not the electronic device is operated by an entity that has such a license. In this way, the electronic device may function as the proxy for the determined merchant of record, thus being authorized to perform the transaction as a proxy for the authorized merchant of record even when the electronic device would not otherwise be authorized outside of the proxy relationship. Various configurations are possible and contemplated without departing from the scope of the present disclosure.

If the transaction is allowed, the flow may proceed to operation 740 where the electronic device may submit a payment processing request as the merchant of record. Otherwise, the flow may proceed to operation 750 where the electronic device may determine that an error has occurred.

In various examples, this example method 700 may be implemented as a group of interrelated software modules or components that perform various functions discussed herein. These software modules or components may be executed within a cloud network and/or by one or more computing devices, such as the identity system device 101 of FIG. 1.

Although the example method 700 is illustrated and described as including particular operations performed in a particular order, it is understood that this is an example. In various implementations, various orders of the same, similar, and/or different operations may be performed without departing from the scope of the present disclosure.

For example, in some implementations, the method 700 may further include receiving a digital representation of a biometric associated with the transaction, retrieving payment information and/or other identity information using the digital representation of the biometric (such as identity information related to whether or not a person is allowed to request the transaction like verified age for an age-restricted product, a verified prescription for a prescription medicine, previous transaction history for frequency and/or amount regulated products, and so on), and/or using such information as part of determining whether nor not the transaction is allowed and/or submitting the payment processing request. Various configurations are possible and contemplated without departing from the scope of the present disclosure.

In various implementations, a system for biometric payment processing that configures payment processing for a determined merchant of record may include at least one non-transitory storage medium that stores instructions and at least one processor. The at least one processor may execute the instructions to receive a digital representation of a biometric and transaction information for a transaction; use the digital representation of the biometric to retrieve identity information; determine a merchant of record for the transaction; configure a token according to the identity information, the transaction information, and a payment processing configuration for the merchant of record; and submit the token to a vault to process a payment for the transaction as the merchant of record.

In some examples, configuring the token according to the payment processing configuration for the merchant of record may include retrieving the payment processing configuration for the merchant of record and configuring the token using a sequence of processes included in the payment processing configuration for the merchant of record. In various examples, configuring the token according to the payment processing configuration for the merchant of record may include including an identification of the configuration to use for processing payment.

In a number of examples, the identity information may include a payment account identifier. In some examples, the identity information may include a name.

In various examples, the payment processing configuration for the merchant of record may specify a sequence of processes that the merchant of record uses to process payments. In a number of such examples, the vault may have a connection to a gateway that has the ability to configure connections for performing the sequence of processes.

In some implementations, a system for biometric payment processing that configures payment processing for a determined merchant of record may include at least one non-transitory storage medium that stores instructions and at least one processor. The at least one processor may execute the instructions to receive a digital representation of a biometric and transaction information for a transaction; use the digital representation of the biometric to retrieve identity information; determine a merchant of record for the transaction; retrieve a payment processing configuration for the merchant of record; and submit a payment processing request for the transaction as the merchant of record to a vault using the identity information, the transaction information, and the payment processing configuration.

In various examples, the transaction may be a restricted transaction. In some such examples, the merchant of record may be authorized to perform the transaction and the system may not be authorized to perform the transaction other than as a proxy for the authorized merchant of record. In a number of such examples, the transaction may be for an age restricted product. In various such examples, the transaction may be for a prescription medication. In a number of such examples, the identity information may include an insurance identifier.

In some examples, the system may enable instant reconciliation and/or nearly instantaneous reconciliation (e.g., within fifteen minutes, within an hour, within a same day, and so on) for the merchant of record.

In a number of implementations, a system for biometric payment processing that configures payment processing for a determined merchant of record may include at least one non-transitory storage medium that stores instructions and at least one processor. The at least one processor may execute the instructions to receive a digital representation of a biometric and transaction information for a transaction; use the digital representation of the biometric to retrieve identity information; determine a merchant of record for the transaction; submit a payment processing request for the transaction as the merchant of record that specifies a payment processing configuration for the merchant of record to a vault using the identity information and the transaction information.

In some examples, the payment processing request may be a first payment processing request, the transaction may be a first transaction, the merchant of record may be a first merchant of record, the payment processing configuration may be a first payment processing configuration, and the at least one processor may be operative to submit a second payment processing request for a second transaction as a second merchant of record that specifies a second payment processing configuration for the second merchant of record to the vault. In various such examples, the first payment processing configuration may specify a first sequence of processes that the first merchant of record uses to process first payments, the second payment processing configuration may specify a second sequence of processes that the second merchant of record uses to process second payments, and the first sequence of processes may be different from the second sequence of processes.

In a number of examples, the at least one processor may determine whether the merchant of record is allowed to perform the transaction. In some examples, the transaction information may include a payment account identifier and the at least one processor verifies the payment account identifier using the identity information. In various examples, the payment processing configuration may specify a sequence of processes to perform credit card reconciliation for the merchant of record.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to biometric payment processing that configures payment processing for a determined merchant of record. A system may receive a digital representation of a biometric and transaction information for a transaction; use the digital representation of the biometric to retrieve identity information; determine a merchant of record for the transaction; and submit a payment processing request for the transaction as the merchant of record configured according to the identity information, the transaction information, and a payment processing configuration for the merchant of record to a vault. In some implementations, the system may retrieve the payment processing configuration and configure the payment processing request accordingly. In other implementations, the system may specify in the payment processing request a payment processing configuration that the vault will use. In various implementations, the payment processing request may be in the form of a secure token that is passed to the vault.

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for biometric payment processing that configures payment processing for a determined merchant of record, comprising:
at least one non-transitory storage medium that stores instructions; and
at least one processor that executes the instructions to:
receive a digital representation of a biometric and transaction information for a transaction;
use the digital representation of the biometric to retrieve identity information;
determine a merchant of record for the transaction;
configure a token according to the identity information, the transaction information, and a payment processing configuration for the merchant of record; and
submit the token to a vault to process a payment for the transaction as the merchant of record.

2. The system of claim 1, wherein configuring the token according to the payment processing configuration for the merchant of record comprises:
retrieving the payment processing configuration for the merchant of record; and
configuring the token using a sequence of processes included in the payment processing configuration for the merchant of record.

3. The system of claim 1, wherein configuring the token according to the payment processing configuration for the merchant of record comprises including an identification of the configuration to use for processing payment.

4. The system of claim 1, wherein the identity information includes a payment account identifier.

5. The system of claim 1, wherein the identity information includes a name.

6. The system of claim 1, wherein the payment processing configuration for the merchant of record specifies a sequence of processes that the merchant of record uses to process payments.

7. The system of claim 6, wherein the vault has a connection to a gateway that has the ability to configure connections for performing the sequence of processes.

8. A system for biometric payment processing that configures payment processing for a determined merchant of record, comprising:
at least one non-transitory storage medium that stores instructions; and
at least one processor that executes the instructions to:
receive a digital representation of a biometric and transaction information for a transaction;
use the digital representation of the biometric to retrieve identity information;
determine a merchant of record for the transaction;
retrieve a payment processing configuration for the merchant of record; and
submit a payment processing request for the transaction as the merchant of record to a vault using the identity information, the transaction information, and the payment processing configuration.

9. The system of claim 8, wherein the transaction is a restricted transaction.

10. The system of claim 9, wherein the merchant of record is authorized to perform the transaction and the system is not authorized to perform the transaction.

11. The system of claim 9, wherein the transaction is for an age restricted product.

12. The system of claim 9, wherein the transaction is for a prescription medication.

13. The system of claim 9, wherein the identity information includes an insurance identifier.

14. The system of claim 8, wherein the system enables instant reconciliation for the merchant of record.

15. A system for biometric payment processing that configures payment processing for a determined merchant of record, comprising:
at least one non-transitory storage medium that stores instructions; and
at least one processor that executes the instructions to:
receive a digital representation of a biometric and transaction information for a transaction;
use the digital representation of the biometric to retrieve identity information;
determine a merchant of record for the transaction;
submit a payment processing request for the transaction as the merchant of record that specifies a payment processing configuration for the merchant of record to a vault using the identity information and the transaction information.

16. The system of claim 15, wherein:
the payment processing request is a first payment processing request;
the transaction is a first transaction;
the merchant of record is a first merchant of record;
the payment processing configuration is a first payment processing configuration; and
the at least one processor is operative to submit a second payment processing request for a second transaction as a second merchant of record that specifies a second payment processing configuration for the second merchant of record to the vault.

17. The system of claim 16, wherein:
the first payment processing configuration specifies a first sequence of processes that the first merchant of record uses to process first payments;
the second payment processing configuration specifies a second sequence of processes that the second merchant of record uses to process second payments; and
the first sequence of processes is different from the second sequence of processes.

18. The system of claim 15, wherein the at least one processor determines whether the merchant of record is allowed to perform the transaction.

19. The system of claim 15, wherein:
the transaction information includes a payment account identifier; and
the at least one processor verifies the payment account identifier using the identity information.

20. The system of claim 15, wherein the payment processing configuration specifies a sequence of processes to perform credit card reconciliation for the merchant of record.
